(19) United States
(12) Patent Application Publication
(10) Pub. No.: US 2016/0031631 A1
(43) Pub. Date: Feb. 4, 2016

(54) UPPER DISCHARGE DISPENSER FOR FOOD OR MEDICINE

(71) Applicant: Gwang Sig KIM, (US)

(72) Inventor: Gwang Sig KIM, Incheon (KR)

(21) Appl. No.: 14/780,019

(22) PCT Filed: Mar. 21, 2014
(86) PCT No.: PCT/KR2014/002382

§ 371 Date: Sep. 25, 2015

(30) Foreign Application Priority Data
Mar. 28, 2013 (KR) 10-2013-0033169

(51) Int. Cl. B65D 83/00; B65D 51/22; B65D 47/08; A61J 7/00; B65D 83/04

(52) U.S. Cl. CPC B65D 83/0038; A61J 7/0076; B65D 83/04; B65D 47/0861; B65D 51/222

(57) ABSTRACT

Disclosed is a very hygienic upper discharge dispenser for food or medicine, which allows a user to open a sealing lid in a one touch way and then, easily take out contents, such as food and medicine, which rise in sequence. The present invention provides an upper discharge dispenser for food or medicine comprising: a cylindrical main body of which an upper part is open and which has a fixing ridge formed on the outside of the upper part; and an upper lid which fits on the outside of the upper side of the main body and is hooked by the fixing ridge, and which has a discharge opening. The discharge opening of the upper lid comprises: a cutting piece formed protrusively on one side so as to be opened along a cutting line; a push button formed on the front end of the upper lid; a hinge groove formed on the rear end of the upper lid; a funnel shaped lift which fits into the main body to move up and down so as to upwardly transfer contents laid thereon; an elevating member which fits into the center of the main body such that the lower end comes into contact with the inner bottom of the main body and the upper end comes into contact with the bottom surface of the lift, thereby providing elastic force to push up contents laid on the lift; a sealing lid in which a fixing tongue hooked by the push button of the upper lid is formed on the front end and a hinge axis is formed on the rear end so as to be inserted into and hooked by the hinge groove of the upper lid; and an elastic member of which one end is coupled, or integrated, to an inside insertion groove of the sealing lid, thereby providing a rotational force when opening the sealing lid.

### TECHNICAL FIELD

The present invention relates to an upper discharge dispenser for food or medicine, and in particular to an upper discharge dispenser for food or medicine wherein a content, for example, a food, a medicine, etc. can be easily taken out in one touch method in such a way that a sealing lid is opened, and the contents which are ascending in order can be easily taken out, which is very sanitary.

### BACKGROUND ART

A conventional dispenser for foods and medicines are described in the Korean patent registration numbers 531604 and 1028943 and the Korean utility model registration numbers 328700 and 354242 which are invented or designed by the inventor of the present invention.

The conventional dispenser is configured in such a way that a discharge port is always open, which may provide a bad sealing effect. In order to discharge a content, for example, a food or a medicine, it needs to open and close a cover in addition to presetting a rotation rotary which rotates horizontal by pressing a button. In order to discharge the content, it needs to lift up a container, which may cause many inconveniences. The structure is complicated, and a manufacturing cost is high.

The containers which allow to discharge one by one the contents in the upward and downward movement methods, not a horizontal rotation method, while improving the above complicated configuration among the above-listed problems are disclosed in the Korean utility model publication number 2001-441 entitled “packing container”, the Korean utility model publication number 2008-3947 entitled “pump type gum discharge container”, the Korean utility model registration number 20-449734 entitled “gum accommodation container”, and the Korean utility model publication number 2011-11341 entitled “gum discharge container”.

The conventional container of the upward and downward movement method includes a cylindrical lower outer cylinder body the top of which is open, wherein a discharge pillar onto which contents are stacked one by one protrudes in the center; an inner cylinder body the center of which is through formed for the discharge pillar of the lower outer cylinder body to pass and which is inserted into an inner side of the lower outer cylinder body and is engaged to ascend or descend upward and downward, wherein the top of the inner cylinder body is open to accommodate contents; and a lid which is configured to close the open top of the inner cylinder body and has a discharge opening so as to discharge the contents stacked on the discharge pillar of the lower outer cylinder body.

In the above conventional container, when a lid is manually lifted so as to take out a content, the inner cylinder body engaged to the lid ascends together. Here, the contents ascend together, and any one of the contents is placed on a top mounting groove of the discharge pillar. Next, if the lid and the inner cylinder body are manually descended or a hand which was holding the things releases the holding things, they descend by their self-weight. When the lid and the inner cylinder body descend to the initial positions, the contents placed on the top mounting groove of the discharge pillar becomes a state where it can be discharged through the discharge opening of the lid, thus discharging the content. Since the discharge pillar of the outer cylinder body is always in an exposed state where it closes the discharge opening of the lid before the lid and the inner cylinder body are manually lifted up so as to take out the contents, dusts, impurities, etc. may get on, which causes a sanitary problem. If the remaining amount of the content is small, a distance for upward and downward operations is long, thus entailing many inconveniences.

### DISCLOSURE OF INVENTION

### Technical of Invention

Accordingly, the present invention is made in an effort to resolve the above mentioned problems. It is an object of the present invention to provide a sanitary upper discharge dispenser for foods or medicine wherein a sealing lid can be opened in one touch method with the aid of an elastic force of an elastic member while providing conveniences when filling a content, for example, foods, medicines, etc., and the contents which are ascending in order by an elevating member can be conveniently taken out.

### Solution to Problem

To achieve the above objects, there is provided an upper discharge dispenser for food or medicine comprising: a cylindrical main body of which an upper part is open and which has a fixing ridge formed on the outside of the upper part; and an upper lid which fits on the outside of the upper side of the main body and is hooked by the fixing ridge, and which has a discharge opening. The discharge opening of the upper lid comprises, but is not limited to, a cutting piece formed protrusively on one side so as to be opened along a cutting line; a push button formed on the front end of the upper lid; a hinge groove formed on the rear end of the upper lid; a funnel shaped lift which fits into the main body to move up and down so as to upwardly transfer contents laid thereon; an elevating member which fits into the center of the main body such that the lower end comes into contact with the inner bottom of the main body and the upper end comes into contact with the bottom surface of the lift, thereby providing elastic force to push up contents laid on the lift; a sealing lid in which a fixing tongue hooked by the push button of the upper lid is formed on the front end and a hinge axis is formed on the rear end so as to be inserted into and hooked by the hinge groove of the upper lid; and an elastic member of which one end is coupled, or integrated, to an inside insertion groove of the sealing lid, thereby providing a rotational force when opening the sealing lid.

In the present invention, it is characterized that the elevating member configured to push up the contents for the sake of easier discharge of the contents is formed of a coil spring or a zigzag type leaf spring, and the elastic member which allows to open the sealing lid configured to prevent the input of any impurities by blocking a discharge opening of the upper lid is formed of an elastic piece or a zigzag type leaf spring.

In the present invention, it is characterized that a lift is configured to be released and ascend when in use while it is being hooked on an inner lower surface of the main body so as to provide any convenience when filling a content, for example, a food or a medicine etc.

### Advantageous Effects

In the present invention, since an engaging protrusion of a lift is inserted into a fixing ring formed at a lower side of the main body, thus maintaining a hooked state, which allows an easier filling of the contents, and a discharge opening may be opened along a cutting line with the aid of a cutting piece of the upper lid, and the hooked state may be released by pressing a pusher of the lift, whereupon the lift can ascend with the aid of an elastic force of the elevating member formed of a coil spring or a zigzag type leaf spring, which allows the contents to be pushed up in order to the position of the discharge opening. To this end, the discharge of the contents is very convenient. When the push button of the upper lid is pressed, the sealing lid can be opened in one touch method with the aid of an elastic recovery force of the elastic member formed of an elastic piece or a zigzag type leaf spring, so the contents positioned at the discharge opening can be easily taken out and eaten. When at normal time, since the upper lid is sealed by the sealing lid, it is very sanitary, and the engaged construction looks simple, and the manufacturing cost is low.

### BRIEF DESCRIPTION OF DRAWINGS

FIGS. 1 and 2 are disassembled perspective views illustrating a plane or bottom surface state of an upper discharge dispenser for food or medicine according to the present invention.

FIG. 3 is a vertical cross sectional view illustrating an engaged state of an upper discharge dispenser for food or medicine according to the present invention.

FIG. 4 is a cross sectional view illustrating a use state of an upper discharge dispenser for food or medicine according to the present invention.

FIG. 5 is a perspective view illustrating an elevating member of another embodiment of an upper discharge dispenser for food or medicine according to the present invention.

FIG. 6 is a perspective view illustrating an elastic member of another embodiment of an upper discharge dispenser for food or medicine according to the present invention.

FIG. 7 is a vertical cross sectional view illustrating a state where the elevating member in FIG. 5 and the elastic member in FIG. 6 are engaged and operate in another embodiment of an upper discharge dispenser for food or medicine according to the present invention.

### BEST MODES FOR CARRYING OUT THE INVENTION

The preferred embodiments of the present invention will be described with reference to the accompanying drawings.

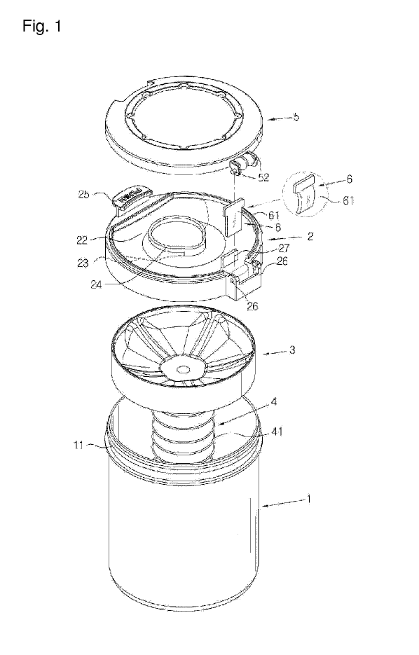

FIGS. 1 to 3 are disassembled perspective views illustrating an upper discharge dispenser for food or medicine and a vertical cross sectional view illustrating an engaged state according to the present invention, wherein a reference number 1 is a main body, 2 is an upper lid, 3 is a lift, 4 is an elevating member, 5 is a sealing lid, and 6 is an elastic member.

The main body 1 is formed in a cylinder shape the top of which is open so as to receive contents, for example, a food, a medicine, etc. and includes a fixing protrusion 11 at an upper outer portion to engage the upper lid 2.

The upper lid 2 is inserted into the top of the main body 1 and may include an engaging protrusion 21 at an inner diameter portion to be hooked by the fixing protrusion 11 of the main body 1, and a discharge opening 22 formed at one side of a horizontal portion to discharge contents.

A cutting line 23 is formed, which allows to cut and open so as to form a discharge opening 22 at one side from the center of the upper lid 2. At a connection portion of one side of the cutting line 23, there is provided a ring-shaped cutting piece 24 which allows to cut away and separate the cutting line 23 with a finger grabbing the same.

In addition, a push button 25 the cross section of which is shaped like “T” is formed at a front end of the upper lid 2, and a hinge groove 26 is formed at a rear end of the upper lid 2 and at a portion of a vertical wall of both sides.

The lift 3 is inserted movable upward and downward in the inside of the main body 1 and is formed in a shape of a funnel so as to push up the contents stacked. The slanted upper surface of the lift 3 is formed of a protruded groove which allows the contents to stably move to the center and smoothly move toward the discharge opening 22 of the upper lid 2.

Meanwhile, an engaging protrusion 31 and a pusher 32 are formed in the center of the lower surface of the lift 3. A fixing ring 12 is formed at a corresponding position in the center of the inner lower surface of the main body 1 for the engaging protrusion 31 to be hooked. A state where the engaging protrusion 31 is hooked by the fixing ring 12 is a space obtaining state where the contents are filled into the main body 1, and the releasing for the sake of content discharges can be obtained in such a way that the pusher 32 is pushed upward through the lower surface of the main body 1, and the engaging protrusion 31 separates from the fixing ring 12.

The elevating member 4 is inserted into the center of the inside of the main body 1, wherein a lower end thereof contacts with the inner bottom of the main body 1, and an upper end of which contacts with the lower surface of the lift 3. The elevating member 4 is configured to provide an elastic force to push upward the contents placed on the lift 3 and supply them to the lower surface of the upper lid 2 and the discharge opening 22.

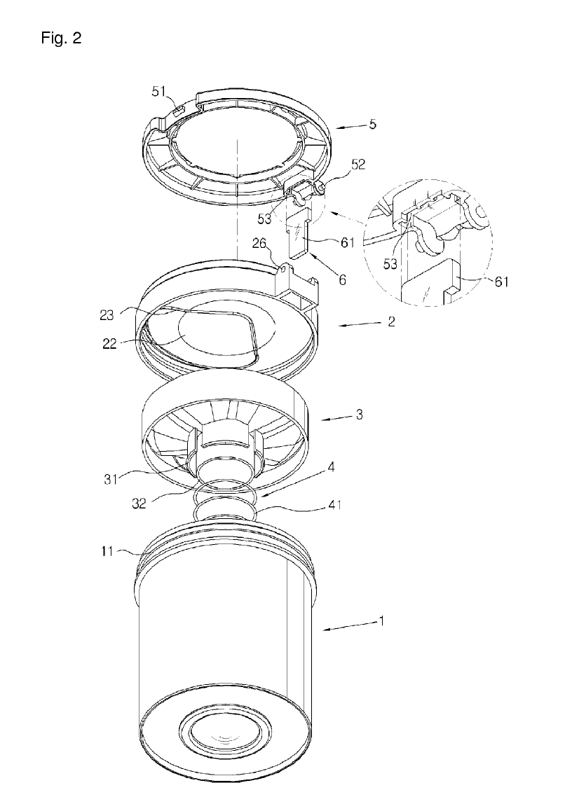

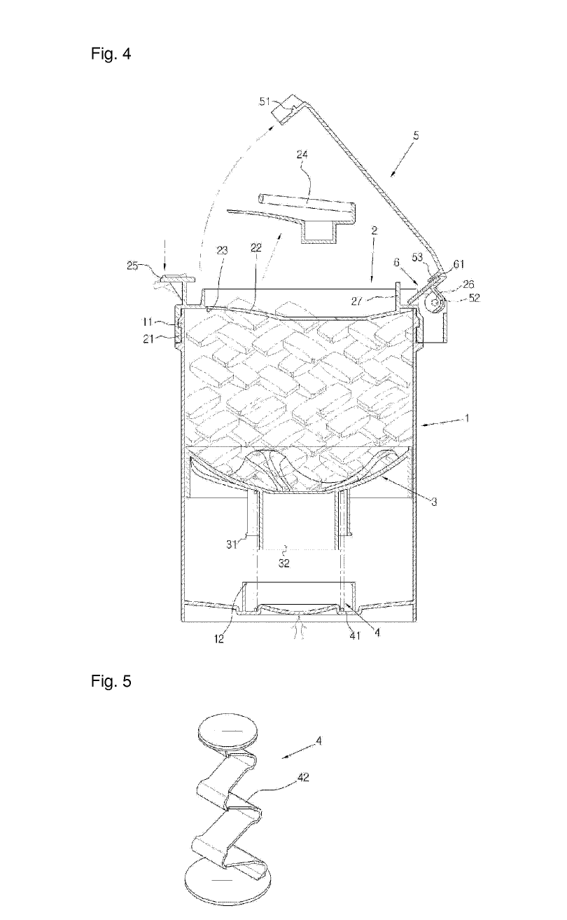

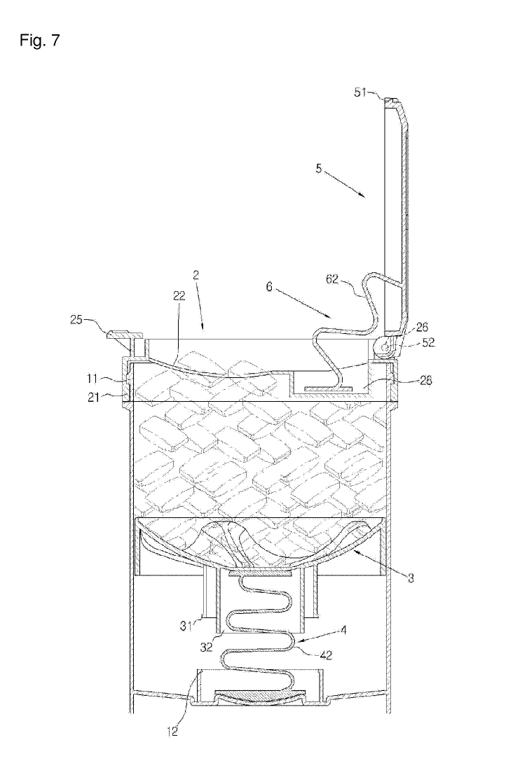

The elevating member 4 may be formed of a metallic coil spring 41 as in FIG. 3 or a zigzag type leaf spring 42 made of a synthetic resin as in FIGS. 5 and 7. The leaf spring 42 is formed integral with the lift 3, thus reducing the number of components. If a metal detector is used so as to detect if a metallic impurity is mixed in the content, it is preferred that the zigzag type leaf spring 42 is used.

The sealing lid 5 is covered into an outer side of the upper lid 2 and is configured to maintain an engaged state so as to maintain a sealed state when delivering and exhibiting. A fixing tongue 51 hooked by the push button 25 of the upper lid 2 is formed at a front end thereof, and a hinge axis 52 is formed at a rear end hereof to be inserted into and hooked by the hinge groove 26 of the upper lid 2.

In addition, there is provided an elastic member 6 one end of which is engaged to the inside insertion groove 53 of the sealing lid 5 or is formed integral thereat so as to provide a rotational force when opening the sealing lid 5.

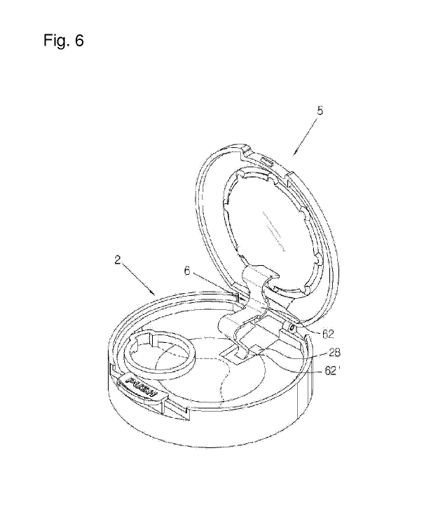

The elastic member 6 is formed of a strap shaped elastic piece 61 the top of which is engaged to the inside insertion groove 53 of the sealing lid 5 as in FIGS. 1 to 3 or a zigzag type leaf spring 62 which is formed integral with the sealing lid 5 as in FIGS. 6 and 7, thus providing a rotational force when opening the sealing lid 5.

In addition, as illustrated in FIGS. 1 and 3, the strap shaped elastic piece 61 may be formed in a flat plate shape or an arc shape.

In addition, an accommodation groove 28 is formed at the upper lid 2 so that the zigzag type leaf spring 62 itself formed integral with the sealing lid 5 and the horizontal portion 62′ formed at a lower portion thereof are accommodated in place, not separating from there.

Therefore, the elastic piece 61 and the leaf spring 62 of the elastic member 6 remain bent or compressed in a state where the sealing lid 5 is covering and sealing the upper lid 2. The moment the engaged fixing tongue 51 of the sealing lid 5 is released in one touch method by pressing the push button 25 formed at the upper lid 2, the sealing lid 5 rotates about the hinge axis 52 based on an elastic recovery force operation of the elastic piece 53 or the leaf spring 62 and becomes upright. On the contrary, if the sealing lid 5 is manually descended, and the fixing tongue 51 is fixed at the push button 25 formed at the upper lid 2, a sealed state is obtained, thus preventing the input of any impurities.

Next, the operations of the upper discharge dispenser for food or medicine according to the present invention will be described below.

First, as illustrated in FIGS. 2 and 3, when the lift 3 is descended manually or using a mechanical operation, and the engaging protrusion 31 of the lift 3 is engaged to the fixing ring 12 of the main body 1, the coil spring 41 or the leaf spring 42 of the elevating member 4 become compressed.

In addition, the contents, for example, a food, a medicine, etc. is filled. The sealing lid 5 is engaged in such a way that the engaging protrusion 21 of the upper lid 2 is fixedly inserted into the fixing protrusion 11 of the main body 1 by inserting the upper lid 2 into the top of the main body 1, thus obtaining a finished sale product in a delivery and exhibition state. The operation of descending and fixing the lift 3 allows to provide many conveniences when filling the contents.

In addition, during the assembling procedure, when the sealing lid 5 engaged by inserting the elastic piece 61 of the elastic member 6 into the inside insertion groove 53 as illustrated in FIG. 2 or the sealing lid 5 having a zigzag type leaf spring 62 of the elastic member 6 as illustrated in FIG. 7 is manually pushed down and descended, the sealing lid 5 rotates about the hinge axis 52, and the fixing tongue 51 of a front end is hooked and fixed by the push button 25 of the upper lid 2, thus obtaining a sealed state.

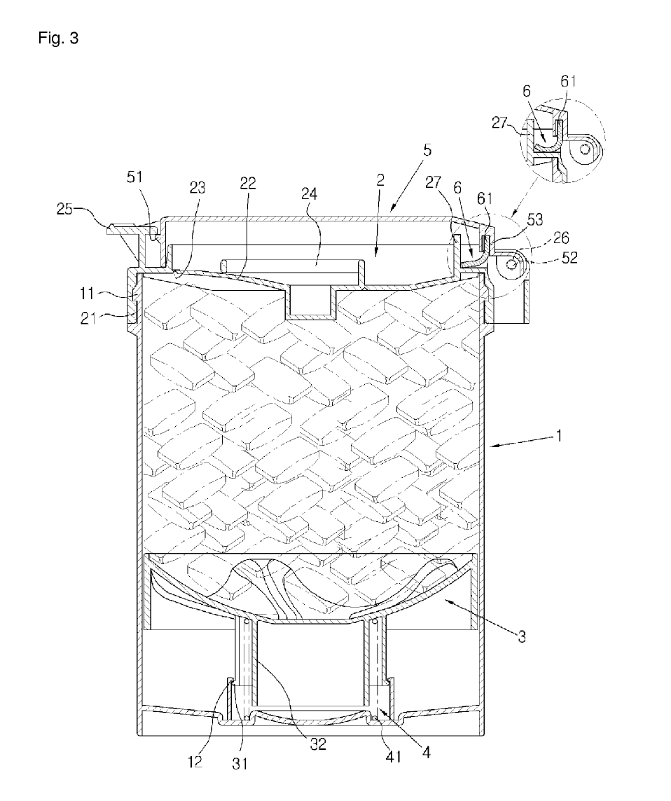

Meanwhile, in a method of releasing the engaged state of the lift 3 so as to eat a product in a delivery state or an exhibited state, as illustrated in FIGS. 4 and 7, the sealing lid 5 is opened by operating the push button 25, and a cutting-away work is performed using the cutting line 23 by pulling the cutting piece 24, thus forming a discharge opening 22. Thereafter, the lower surface of the main body 1 is manually pushed upward, whereupon the pusher 32 of the lift 3 is pushed up together. At this time, the fixing ring 12 of the lift 3 is widened outward with the aid of the pressing operation which allows to push upward, so the engaged state of the engaging protrusion 31 of the lift 3 is released, and at the same time the lift 3 ascends with the aid of a repulsive force operation of the coil spring 41 which is the elevating member 4 or the zigzag type leaf spring 42, whereupon the contents are pushed toward the upper lid 2.

At this time, a part of the contents ascended by the lift 3 contacts with the lower surface of the upper lid 2, thus limiting a further ascending, and the user can grab the contents placed at the discharge opening 22 and can easily take out, thus eating.

Next, when the sealing lid 5 is manually descended by pressing with force, which was upright, so as to easily take out the contents with the aid of the recovery force of the elastic piece 61, which is the elastic ember 6, or the zigzag type leaf spring 62, the fixing tongue 51 at the front end of the sealing lid 5 rotates about the hinge axis 52 and is hooked and fixed by the push button 25 of the upper lid 2. At this time, as illustrated in FIG. 3, the lower end of the elastic piece 61 contacts with the supporting tongue 27 and is bent at about an angle of 90°, thus obtaining an elastic force for recovery. The zigzag type leaf spring 62 is compressed and is accommodated in the accommodation groove 28 of the upper lid 2, thus obtaining an elastic force for recovery, and the sealing lid 5 covers and seals the upper lid 2, thus preventing the input of any impurities.

In addition, the sealing lid 5 allows to very easily expose the discharge opening 22 with the aid of the releasing operation wherein the push button 25 formed at the upper lid 2 is pressed in one touch method and the recovery force of the elastic member 6 of the sealing lid 5, whereupon it is possible to easily take out the contents.

Therefore, the present invention can provide easy assembling of the main body 1, which is formed separable or integral, the upper lid 2, the lift 3, the elevating member 4, the sealing lid 5 and the elastic member 6. It also provides convenience when the lift 3 is fixed at the lower side of the main body 1, and then the contents are filled. It also provides easiness in the way that when the sealing lid 5 which was preventing the input of impurities, for example, dusts, etc. in terms of sanitary matter is released with one touch from the fixed state, the sealing lid 5 can be conveniently opened with the aid of an elastic force operation of the elastic piece 41 which is engaged integral or of the elastic member 6, which is the zigzag type leaf spring 62. In addition, it also provides convenience in the way that it is possible to conveniently take out through the discharge opening 22 the contents which are being pushed up in order by the elastic force of the coil spring 41, which is the elevating member 4, or of the leaf spring 42 at the moment the sealing lid 5 is opened, whereupon the present invention is very useful inventions.

In addition, if the elevating member 4 configured to push upward the contents is formed of a zigzag type leaf spring 42 made of a synthetic resin material, a metal detection from the contents is easy, so it is very sanitary and safe.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

The present invention relates to an upper discharge dispenser for food or medicine, and in particular to an upper discharge dispenser for food or medicine wherein a content, for example, a food, a medicine, etc. can be easily taken out in one touch method in such a way that a sealing lid is opened, and the contents which are ascending in order can be easily taken out, which is very sanitary.

1. An upper discharge dispenser for food or medicine formed of a main body the top of which is open, and which is formed in a cylindrical shape with a fixing protrusion at its upper outer side, and an upper lid which is formed at an inner diameter portion an engaging protrusion inserted into an upper outer portion of the main body and is engaged as it is hooked by the fixing protrusion and has a discharge opening at its horizontal portion, the discharge opening of the upper lid comprises:
a cutting piece which is formed protrusively on one side so as to be opened along a cutting line;
a push button which is formed on the front end of the upper lid;
a hinge groove which is formed on the rear end of the upper lid;
a funnel shaped lift which fits into the main body to move up and down so as to upwardly transfer contents laid thereon;
an elevating member which fits into the center of the main body such that the lower end comes into contact with the inner bottom of the main body and the upper end comes into contact with the bottom surface of the lift, thereby providing elastic force to push up contents laid on the lift;
a sealing lid in which a fixing tongue hooked by the push button of the upper lid is formed on the front end and a hinge axis is formed on the rear end so as to be inserted into and hooked by the hinge groove of the upper lid; and
an elastic member one end of which is coupled, or integrated, to an inside insertion groove of the sealing lid, thereby providing a rotational force when opening the sealing lid.

2. The upper discharge dispenser for food or medicine of claim 1, wherein the elevating member is formed of a metallic coil spring or a zigzag type leaf spring made of a synthetic resin material.

3. The upper discharge dispenser for food or medicine of claim 2, wherein the leaf spring is formed integral with the lift.

4. The upper discharge dispenser for food or medicine of claim 1, wherein the elastic member is a strap type elastic piece the top of which is engaged to the inside insertion groove of the sealing lid and the bottom of which contacts with a supporting tongue protruding in a vertical direction.

5. The upper discharge dispenser for food or medicine of claim 1, wherein the elastic member is a zigzag type leaf spring which is formed integral with the sealing lid, and an accommodation groove is formed at the upper lid so as to accommodate the zigzag type leaf spring itself and a horizontal portion formed at a lower portion thereof.

6. The upper discharge dispenser for food or medicine of claim 1, wherein an engaging protrusion and a pusher are formed at a lower surface of the lift, and a fixing ring is formed at an inner lower surface of the main body so as to engage the engaging protrusion of the lift, thus engaging and disengaging each other.
